(19) United States
(12) Patent Application Publication
(10) Pub. No.: US 2005/0132385 A1
(43) Pub. Date: Jun. 16, 2005

(54) System and method for creating and executing rich applications on multimedia terminals

(76) Inventor: Mikael Bourges-Sevenier, Cupertino, CA (US)

Correspondence Address: DAVID A. HALL, HELLER EHRMAN ET AL., 4350 LA JOLLA VILLAGE DRIVE #700, SAN DIEGO, CA, 92122, US

(21) Appl. No.: 10/959,460

(22) Filed: Oct. 6, 2004

Related U.S. Application Data
(60) Provisional application No. 60/509,228, filed on Oct. 6, 2003.

(51) Int. Cl. G06F 3/00

(52) U.S. Cl. 719/328; 719/329

(57) ABSTRACT

A Scene Controller provides an interface between a multimedia terminal and an application so as to decouple application logic from terminal rendering resources and permits an application to modify the scene being drawn by the terminal during a frame. When the terminal is ready to render a frame, the terminal queries all SceneControllerListeners (from one or many applications) for any pending modifications to the scene being drawn. Each SceneControllerListener may execute modifications to the scene. When all modifications have been applied, the terminal finishes rendering the frame. Finally, the terminal queries each of the SceneControllerListeners for any post-rendering scene modifications. The scene may comprise a high-level description (e.g. a scene graph) or low-level graphical operations.

### REFERENCE TO PRIORITY DOCUMENT

This application claims priority to pending U.S. Provisional Application Ser. No. 60/509,228 filed Oct. 6, 2003 by Mikaël Bourges-Sevenier entitled “System and Method for Creating Rich Applications and Executing Such Applications on Multimedia Terminals”, which is incorporated herein by reference in its entirety.

### BACKGROUND

Multimedia applications enable the composition of various media (e.g. audio, video, 2D, 3D, metadata, or programmatic logic), and user interactions over time, for display on multimedia terminals and broadcast of audio over speakers. Applications and associated media that incorporate audio, video, 2D, 3D, and user interaction will be referred to in this document as relating to “rich media”. Multimedia standards, such as MPEG-4 (ISO/IEC 14496), VRML (ISO/IEC 14772), X3D (ISO/IEC 19775), DVB-MHP, and 3G, specify how to mix or merge (or, as it is called in the computer graphics arts, to “compose”) the various media so that they will display on the screens of a wide variety of terminals for a rich user experience.

A computer that supports rendering of scene descriptions according to a multimedia standard is referred to as a multimedia terminal of that standard. Typically, the terminal function is provided by installed software. Examples of multimedia terminal software include dedicated players such as “Windows Media Player” from Microsoft Corporation of Redmond, Wash., USA and “Quicktime” from Apple Computer of Cupertino, Calif., USA. A multimedia application typically executes on a multimedia server and provides scene descriptions to a corresponding multimedia terminal, which receives the scene descriptions and renders the scenes for viewing on a display device of the terminal. Multimedia applications include games, movies, animations, and the like. The display device typically includes a display screen and an audio (loudspeaker or headphone) apparatus.

The composition of all these different media at the multimedia terminal is typically performed with a software component, called the compositor, that manages a tree (also called a scene graph) that describes how and when to compose natural media (e.g. audio, video) and synthetic media (e.g. 2D/3D objects, programmatic logic, metadata, synthetic audio, synthetic video) to produce a scene for viewing. To display the composed scene, the compositor typically traverses the tree (or scene graph) and renders the nodes of the tree; i.e. the compositor examines each node sequentially and sends drawing operations to a software or hardware component called a renderer based upon the information and instructions in each node.

The various multimedia standards specify that a node of the scene tree (or scene graph) may describe a static object, such as geometry, textures, fog, or background, or may describe a dynamic (or run-time) object, which can generate an event, such as a timer or a sensor.

For extensibility, i.e. to allow a developer to add new functionality to the pre-defined features of a multimedia standard, multimedia standards define scripting interfaces, such as Java or JavaScript, that enable an application to access various components within the terminal. However, very few applications have been produced to date that use these scripting interfaces.

A computer device that executes software that supports viewing rich media according to the MPEG-4 standard will be referred to as an MPEG-4 terminal. Such terminals typically comprise desktop computers, laptop computers, set-top boxes, or mobile devices. An MPEG-4 terminal typically includes components for network access, timing and synchronization, a Java operating layer, and a native (operating system) layer. In the Java layer of the MPEG-4 terminal, a Java application can control software and hardware components in the terminal. A ResourceManager object in the Java layer enables control over decoding of media, which can be used for graceful degradation to maintain performance of the terminal. A ScenegraphManager object enables access to the scene tree (or, as it is called in MPEG-4, the BIFS tree).

MPEG-J is a programmatic interface (“API”) to the terminal using the Java language. MPEG-J does not provide access to rendering resources but allows an application to be notified for frame completion. Therefore, there is no possibility for an application to control precisely what is displayed (or rendered) during a frame, because rendering is controlled by the terminal and not exposed through MPEG-J. Precise control of rendering is very important if an application is to modify the rendered scene at a frame and to adapt quickly in response to events such as user events, media events, or network events. The lack of precise application control hinders the presentation of rich media at MPEG-4 terminals.

One reason that relatively few rich media applications have been produced is that the nodes of the scene graph, as allowed by these conventional standards, permit run-time objects that generate events that may collide or conflict with the logic of an application. The possibility of such conflicts makes the realization of an application hard to implement and undercuts any guarantee that the application will behave identically across different terminals. Since one of the goals of any standard is that an application be able to run across different terminals, the inherent problem in allowing run time objects in the nodes, which may conflict with applications, frustrates one of the goals of these standards. The possibility of conflict arises when a run-time event is sent to both the multimedia application at the server and multimedia player at the terminal, whereupon the event may disrupt operation of the application and cause delay or error at the terminal.

Although rendering in a 2D application is not a complex issue, rendering in a 3D application may involve the generation of a large number of polygons. To avoid unacceptably low frame rates in displaying scenes on a terminal, it is desirable to be able to manage how these polygons are processed and displayed. A system and method for creating rich applications and displaying them on a multimedia terminal in which the applications are able to control what is sent to the renderer will improve the user experience.

Typically, 3D applications use culling algorithms to determine what is visible from the current viewpoint of a scene. These algorithms are executed at every rendering frame prior to rendering the scene. Although executing such algorithms may take some time to perform, the rendering performance can be drastically improved by culling what is sent to the graphics card.

From the discussion above, it should be apparent that there is a need for improved control of frame rendering, including improved rendering of nodes, control over run time object conflicts, and culling of data in a multimedia system and increased network availability. The present invention solves this need.

### SUMMARY

In accordance with the invention, a scene controller of a multimedia terminal provides an interface between the multimedia terminal and an application. The scene controller decouples application logic from terminal rendering resources and allows an application to modify the scene being drawn on the display screen by the terminal during a frame rendering process. Before rendering a frame, the terminal queries registered scene listener components (from one or many applications) for any modifications to the scene. Each scene listener may execute modifications to the scene. When all modifications have been applied to the scene, the terminal renders the scene. Finally, the terminal queries each of the scene listeners for any post-rendering modifications of the scene. Thus, a scene controller in accordance with the invention checks the status of an input device for every frame of a scene description that is received, updates the described scene during a rendering operation, and renders the scene at the multimedia display device. The scene controller controls the rendering of a frame in response to user inputs that are provided after the frame is received from an application. In this way, the SceneController manages rendering of scenes in response to events generated by the user at the terminal player without delay.

The scene may comprise a high-level description (e.g. a scene graph) or may comprise low-level graphical operations. Because the scene listeners are called synchronously during the rendering of a scene, no special synchronization mechanism is required between the terminal and the applications. This results in more efficient rendering of a scene.

In one aspect, the scene controller comprises a SceneController program architecture design pattern that includes two components: a SceneControllerManager and a SceneControllerListener. For multimedia scene processing, the SceneControllerManager processes frames of a scene graph and determines how the frame should be rendered. A rich media application that is executed at the multimedia terminal implements the SceneControllerListener so it can listen (that is, receive) messages from the SceneControllerManager. The SceneControllerListener could be thought as a type of application-defined compositor, since it updates the scene being drawn at each frame in response to user events, media events, network events, or simply the application's logic. This means that application conflicts with the user-generated events will not occur and frames will be efficiently rendered. Moreover, because the operations are sequential, there is no need for synchronization mechanisms, which would otherwise slow down the overall terminal performance.

The SceneController pattern can be used to manage components other than a scene. For example, decoders can be implemented so that a registered application can be listening to decoder events. The same sequence of operations for the SceneController will apply to such decoders and hence the same advantages will accrue: there is no need for complex multi-threading management and therefore much higher (if not optimal) usage of resources (and for rendering much higher frame rates) can be obtained. This is extremely important for low-powered devices where multithreading can cost many CPU cycles and thus frames. That is, the SceneController pattern described in this document is not limited to performing control of scene processing, but comprises a pattern that can be used in a variety of processing contexts, as will be recognized by those skilled in the art.

Other features and advantages of the present invention should be apparent from the following description of the preferred embodiments, which illustrate, by way of example, the principles of the invention.

### BRIEF DESCRIPTION OF DRAWINGS

FIG. 1 shows the architecture of a complete MPEG-4 terminal constructed in accordance with the invention.

FIG. 2 is an illustration of scene controller use cases.

FIG. 3 is a class diagram for the SceneController object that shows the relationships between the objects used in a rendering loop.

FIG. 4 is an illustration of the FIG. 3 SceneController sequence of operations.

FIG. 5 is an illustration of a sequence of operations for a scene controller used to receive events from a data source such as a network adapter or a decoder.

FIG. 6 is an illustration of a sequence of operations for a scene controller used as a picking manager (so the user can pick or select objects on the screen).

FIG. 7 is an illustration of a sequence of operations for a VisibilitySensor node.

FIG. 8 is an illustration of a sequence of operations for MPEG-4 BIFS and AFX decoders in accordance with the invention.

FIG. 9 is an illustration of a sequence of operations for a BitWrapper implementation.

FIG. 10 is a block diagram of a computer constructed in accordance with the invention to implement the terminal illustrated in FIG. 1.

### DETAILED DESCRIPTION

In accordance with the invention, an extensible architecture for a rich media terminal enables applications to control scene elements displayed at each frame and can solve problems inherent thus far in multimedia standards. A system designed with the disclosed architecture enables a scene controller to implement any or all of the following:
a) Culling algorithms;
b) Scene navigation;
c) Network events that modify the topology of the scene;
d) Any component that needs to interact with nodes of the scene graph such as media decoders and user input devices.

A system using the extensible architecture described herein has a significant benefit: it is predictable. The predictability is achieved because scene controllers as described herein will process user input events and propagate such inputs during a frame. Because events are always sent during a frame, the scene listeners can always access a scene when the scene is in a coherent state. This ensures more stable and predictable rendering. In contrast, for conventional multimedia standards such as MPEG-4, VRML, or X3D, a dynamic node may generate events, but the event notification mechanism is not deterministic. As a result, an action triggered by such user input events may not occur at a precise frame and hence may be missed by listeners that are monitoring the state of a scene for a particular frame. Thus, for such multimedia schemes, the frame during which an event might be rendered is not reliably predicted.

Using the disclosed scene controller design, software developers can extend a SceneController design pattern to provide a multimedia terminal that dramatically improves performance of applications because the SceneController pattern results in no event generation in the rendering loop. Rather, event generation takes place prior to the rendering loop, and occurs under control of a SceneControllerManager of the terminal. This guarantees the sequence of execution of applications across terminals.

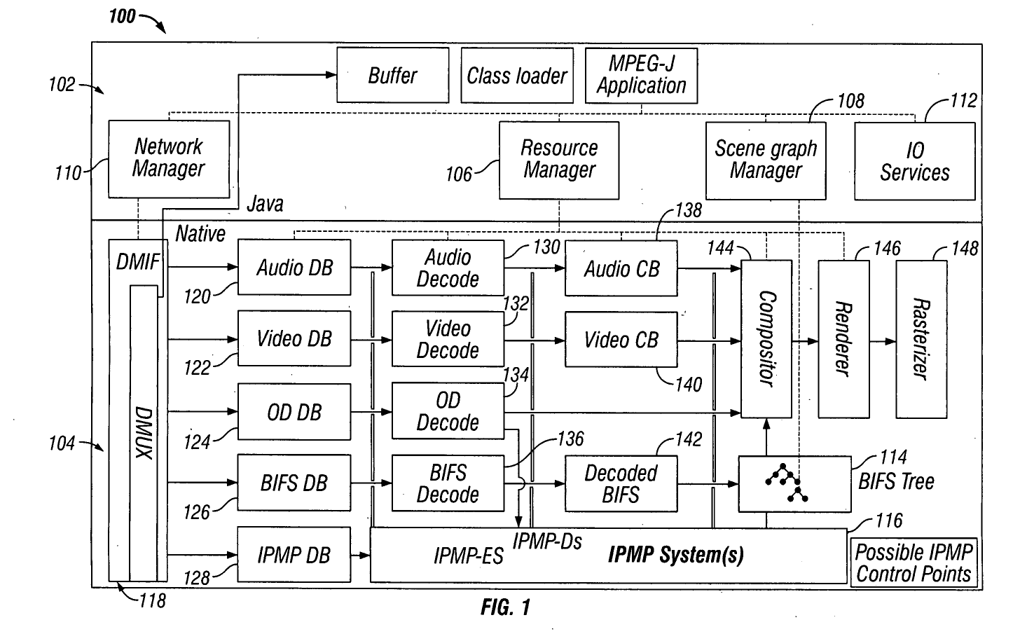

FIG. 1 shows the architecture of a complete MPEG-4 multimedia terminal 100 constructed in accordance with the invention. The terminal 100 generally comprises software that is installed in a computer device, which may comprise a desktop computer, laptop computer, or workstation or the like. As noted above, conventional multimedia terminals include “Windows Media Player” and the “Quicktime” player. FIG. 1 shows that the MPEG-4 terminal in accordance with the present invention includes a Java programming layer 102 and a native (computer operating system) layer 104. Other multimedia specifications generally use a similar architecture with different blocks, mostly for network access, timing, and synchronization. The terminal 100 can receive frame descriptions in accordance with a multimedia standard and can render the frames in accordance with that standard.

In FIG. 1, the Java layer 102 shows the control that a Java application can have on software or hardware components of the terminal device. The Resource Manager 106 enables control over decoding of media, which can be used for graceful degradation to maintain performance of the terminal 100, in case of execution conflicts or the like. The Scenegraph Manager 108 of the Java layer enables access to the scene tree (or, as it is called in MPEG-4, the BIFS tree). The Network Manager 110 is the Java component that interfaces with corresponding network hardware and software of the computer device to communicate with a network. The IO Services component 112 interfaces with audio and video and other input/output devices of the computer device, including display devices, audio devices, and user input devices such as a keyboard, computer mouse, and joystick. The BIFS tree 114 is the frame description received at the terminal from the application and will be processed (traversed) by the terminal to produce the desired scene at the display device. The IPMP Systems 116 refers to features of the MPEG-4 standard relating to Intellectual Property Management and Protection. Such features are described in the document ISO/IEC JTC1/SC29/WG11, Coding of Moving Pictures and Audio, December 1998, available from International Standards Organization (ISO). The DMIF (Delivery Multimedia Integration Framework) block 118 represents a session protocol for the management of multimedia streaming over generic delivery technologies. In principle it is similar to FTP. The primary difference is that FTP returns data, whereas DMIF returns pointers to where to get (streamed) data.

The Audio Decoder Buffer (DB) 120, Video DB 122, Object Descriptor (OD) DB 124, BIFS DB 126, and IPMP DB 128 represent various decoder outputs within the MPEG-4 terminal 100, and are used by the computer device in operating as a multimedia terminal and rendering frames. The respective decoder buffers 120-126 are shown in communication with corresponding decoders 130-136. The Audio Composition Buffer (CB) 138 represents an audio composition buffer, which can reside in computer memory or in an audio card of the computer or associated software, and the Video CB 140 represents a video composition buffer, which can reside in memory, a graphics card, or associated software. The decoded BIFS (Binary Format for a Scene) data 142 is used to construct the BIFS 114 tree referred to above, which in turn is received by the Compositor 144 for frame rendering by the Renderer 146 followed by graphics processing by the Rasterizer 148. The Rasterizer can then provide its output to the graphics card.

In MPEG-J, the Application Programming Interface (“API”), the Compositor, and the Renderer are treated as one component, and only frame completion notification is defined; there is no possibility to control precisely what is displayed (or rendered) at every frame from an application stand-point. In fact, MPEG-J allows only access to the compositor of a multimedia terminal, as do other multimedia standards, by allowing access to the scene description. The SceneController pattern of the present invention enables access to the compositor and hence modification of the scene description during rendering, thereby allowing access to the renderer either via high-level interfaces (a scene description) or low-level interfaces (drawing operations).

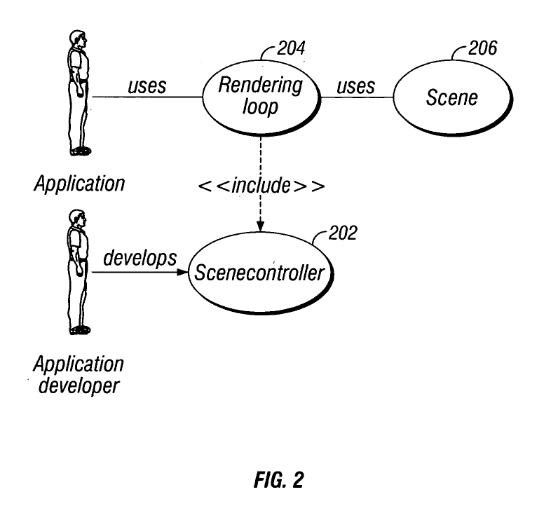

As shown in FIG. 2, the scene controller scenario 202 in accordance with the invention is included inside the rendering loop scenario 204 because the scene controller is called at every frame 206 by the corresponding applications. That is, a SceneControllerListener object for each registered application is called for each frame being rendered. An application developer can implement application-specific logic by extending the SceneControllerListener interface and registering this component with the Compositor of the terminal. Thus, the SceneController pattern 202 is extended by a developer to implement scene processing and define a Compositor of a terminal that operates in conjunction with the description herein. That is a player or application constructed in accordance with the invention will comprise a multimedia terminal having a SceneController object that operates as described herein to control rich media processing during each frame.

Controlling what is sent to a graphics card is often called using the immediate mode because it requires immediate rendering access to the card. In multimedia standards, the retained mode is typically defined via usage of a scene graph that enables a renderer to retain some structures before sending them to the rasterizer. The scene controller pattern described herein permits processing of graphics card operations during frame rendering by virtue of instructions that can be passed from the listener to the scene controller manager. Therefore, the scene controller pattern enables immediate mode access in specifications that only define retained mode access.

Although components called “scene controllers” have been used in the past in many applications, the architecture disclosed and described herein incorporates a scene controller comprising an application-terminal interface as a standard component in rendering multimedia applications, enabling such multimedia applications to render scenes on any terminal. This very generic architecture can be adapted into any application—one that is standard-based or one that is proprietary-based. The system and method for controlling what is rendered to any object, disclosed and described herein, enables developers to create a wide variety of media-rich applications within multimedia standards.

In MPEG-4, VRML, and X3D, the events generated by dynamic objects may leave the scene in an unstable state. Using scene controllers as described herein, it is always possible to simulate the behavior of such event generators, without the need of threads and synchronization, thereby guaranteeing the best rendering performance. The behavior of other system components, however, may slow down the rendering performance if such components consume excess CPU resources.

Using the scene controller pattern described herein, an application can create its specific, run-time, dynamic behavior. This enables more optimized applications with guaranteed, predictable behavior on any terminal. This avoids relying on similar components defined by the standard that might not be optimized, not extensible for the needs of one's application.

1 Scene Controller Architecture

1.1 SceneController—Static View

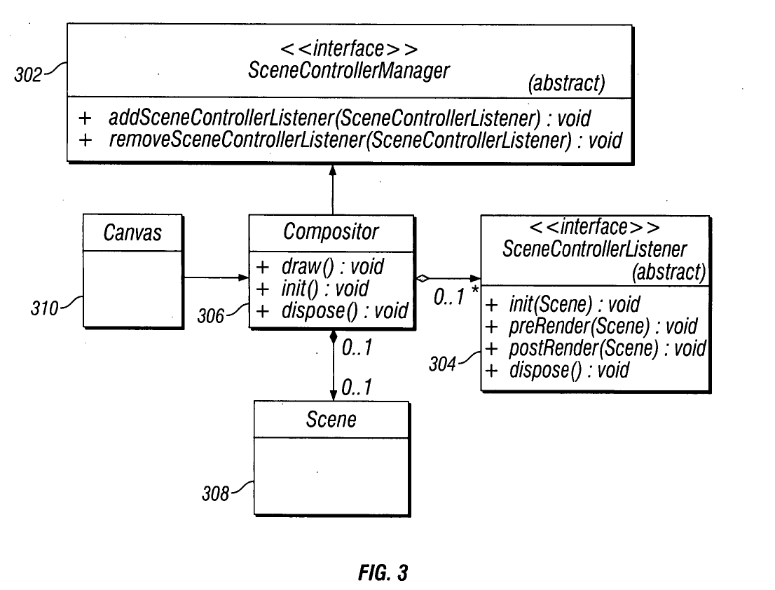

FIG. 3, using Unified Modeling Language notation, shows the relationships between the objects used in a rendering loop, as listed below:
a) SceneControllerManager interface 302 can be implemented by a Compositor object or a Renderer object (an object that is implemented from the SceneController pattern described herein). This interface enables a SceneControllerListener to be registered with a Compositor.
b) SceneControllerListener interface 304 defines four methods that any SceneControllerListener must implement. These four methods are called by the SceneControllerManager during the life of a SceneControllerListener: init( ) at creation, preRender( ) and postRender( ) during rendering of a frame, and dispose( ) at destruction.
c) Compositor 306 is an object that holds data defining the Scene.
d) Scene 308 is an object that contains a scene graph that describes the frame to be rendered and is traversed at each rendering frame by the Compositor.
e) Canvas 310 is an object that defines a rectangular area on the display device or screen where painting operations will be displayed.

It should be noted that Compositor, Canvas, and Scene are generic terms for the description of aspects of the SceneController pattern as described herein. Those skilled in the art will understand the multimedia scene features to which these terms refer. A particular implementation may use completely different names for such features (objects).

As described further below, applications that require services of the multimedia terminal register with the SceneControllerManager 302 when they are launched. As each application is launched and registered, the SceneControllerManager adds a corresponding SceneControllerListener object 304, as illustrated in FIG. 3. When an application is closed, its corresponding listener is removed. Thus, the SceneControllerManager maintains a list of registered applications. When a frame is to be rendered, the SceneControllerManager calls the registered applications according to its list by polling the listener objects for requested service. The polling is in accordance with the applications that are registered in the manager's list.

FIG. 3 shows that the Compositor 306 includes a draw( ) method that generates instructions and data for the terminal renderer, to initiate display of the scene at the computer device. The Compositor also includes an initialization method, init( ), and includes a dispose( ) method for deleting rendered frames.

1.2 SceneController—Dynamic View

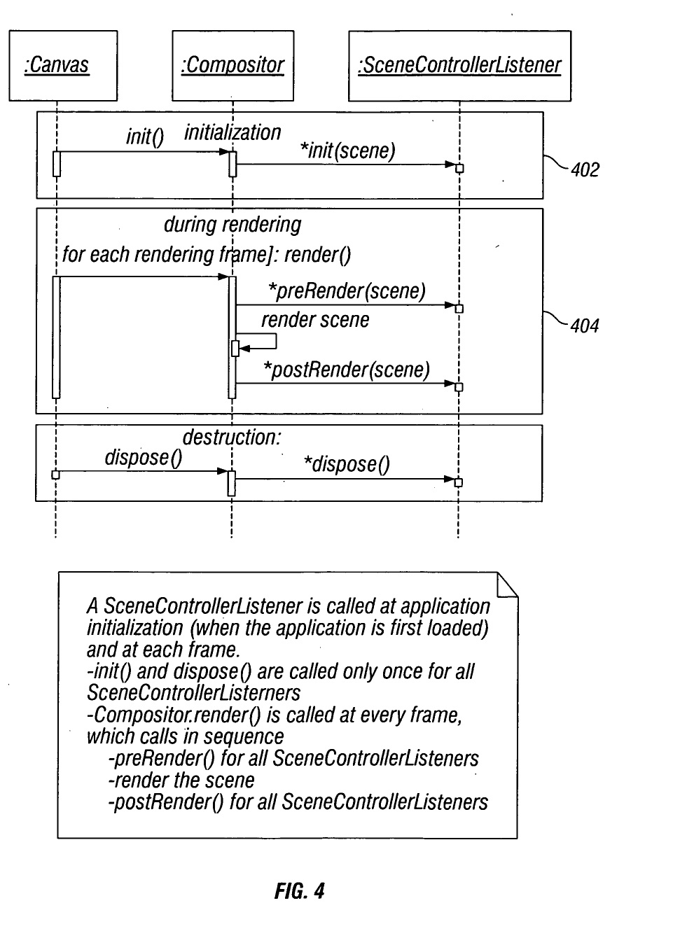

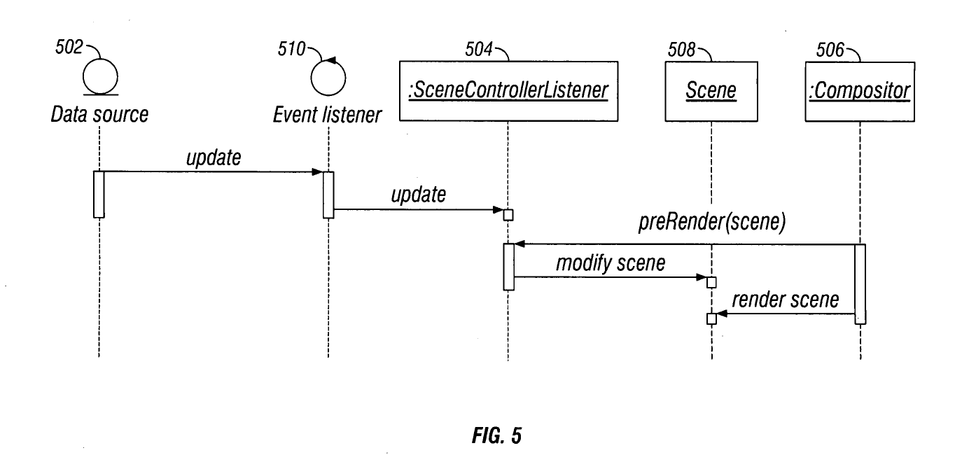

Referring to FIG. 4, the sequence of operations for a SceneControllerListener object is illustrated. Those skilled in the art will appreciate that FIG. 4 (as well as FIGS. 5 through 9) illustrate the sequence of operations executed by a computer device that is programmed to provide the operations described herein. These flow charts are consistent with the Unified Modeling Language notation.

When a SceneControllerListener is registered to the Compositor, a SceneControllerListener.init( ) method is called to ensure its resources are correctly initialized. It is preferred that each application register with the SceneControllerManager of the multimedia terminal upon launch of the application that will be using the terminal. A program developer, however, might choose to have applications register at different times. In addition, a developer might choose to provide a renderer, but not a compositor. That is, a terminal developer might choose to have a compositor implement the SceneControllerManager interface, or might choose to have the manager functions performed by a different object. Those skilled in the art will be able to choose the particular registration and management scheme suited to the particular application that is involved, and will be able to implement a registration process as needed.

FIG. 4 shows that the init( ) method is performed at application initialization time 402. FIG. 4 shows that at each rendering frame 404, the SceneControllerListener.preRender( ) method is called by the SceneControllerManager. Then, the scene is rendered. Finally, the SceneControllerListener.postRender( ) method is called.

The SceneControllerListenerpreRender( ) method is used to control the objects to be displayed at the frame being processed. This method can be used to permit the terminal to query the application as to what tasks need to be performed. The task might be, for example, to render the frame being processed. Other tasks can be performed by the listener object and will depend on the nature of the SceneController pattern extensions by the developer. The SceneControllerListener.postRender( ) method might be used for 2D layering, compositing effects, special effects, and so on, once the scene is rendered. The postRender( ) method may also be used for picking operations, i.e. to detect if the user's pointing device (e.g. a mouse) hits a scene object on the display screen. Thus, prior to drawing a scene on the display device, the SceneControllerListener uses preRender( ) to check for event messages such as user mouse pointer movement and then uses postRender( ) to check for scene collisions as a result of such user movements.

1.3 Synchronization

Because SceneControllerListeners are called synchronously during the rendering of a scene, no synchronization mechanism is required between the terminal and the applications; this results in more efficient rendering of a scene.

Synchronization between the application, the terminal, and the frame received at the terminal from the application is important for more efficient processing, and is automatically achieved by the SceneController pattern described herein by virtue of the SceneController placement within the frame processing loop.

No specific synchronization mechanism is required because the renderer of the terminal is running in its own thread and the applications (SceneControllerListeners) run in their own threads.

1.4 Scene Controllers Usage

Scene controllers as described herein can be extended from the disclosed design pattern (SceneController) and used for many operations. The following description gives examples of SceneController usage scenarios and is not limited to these scenarios only.

a) User interaction
i) Navigation. As the user moves in a scene, the navigation controller controls the active camera. The controller receives events from device sensors (mouse, keyboard, joystick etc.) and maps them into camera position

b) Object-Object interaction
i) Objects (including the user) may collide together. A scene controller can monitor such interactions in order to trigger some action

c) Network interaction
i) A player receives data packets or access units (as an array of bytes) from a stream (from a file or from a server). An access unit contains commands that modify the scene graph. Such a scene controller receives the commands and applies them when their time matures.
d) Scene manipulation
i) When rendering a frame, new nodes can be created and inserted in the rendered scene.
ii) A typical application with a complex logic may use the BIFS stream to carry the definition of nodes (e.g. geometry). Then, it would retrieve the geometry, associate logic and create the scene the user interacts with.
iii) In multi-user applications, multiple users interact with the scene. Each user can be easily handled by a scene controller.
e) Scene rendering optimization
i) Camera management can be handled by a scene manager as well as navigation. In addition, view-frustrum culling can be performed so to reduce the number of objects and polygons sent to the graphic card.
ii) More complex algorithms such as occlusion culling can also be performed by a scene manager.

FIG. 5 shows a generic example where events coming from a DataSource 502 (in general, data packets) update the state of a SceneControllerListener 504 so that, at the next rendering frame, when the Compositor 506 calls the SceneControllerListener object, the SceneControllerListener object can update/modify the scene 508 appropriately.

The EventListener object 510 listens to events from the DataSource 502. A DataSource object may implement EventListener and SceneControllerListener interfaces but is not required to. The events that are received from the DataSource comprise event messages, such as computer mouse movements of the user, or user keyboard inputs, or joystick movements, or the like.

2 Scene Controller as a Fundamental MPEG-J Extension

2.1 Background

As noted above, FIG. 1 describes the architecture of an MPEG-4 terminal. This architecture can be broken down into a systems layer and an application layer. The systems layer extends from the network access (Network Manager) to the Compositor, and the application layer corresponds to the remainder of the illustration. Those skilled in the art will understand that, even though the discussion thus far relates to MPEG-4, the SceneController design pattern described herein can be utilized in conjunction with any multimedia standard, such as DVB-MHP, 3G, and the like.

The Compositor of the terminal uses the BIFS tree (i.e. MPEG-4 scene description) to mix or to merge various media objects that are then drawn onto the screen by the renderer. The MPEG-4 standard does not define anything regarding the Renderer; this is left to the implementation.

To extend the features defined by the standard in the BIFS tree, three mechanisms are defined:
a) Using PROTO, which is a sort of macro to define portions of the scene graph that can be instantiated at run-time with BIFS features therein
b) Using JavaScript
c) Using Java language through the MPEG-J interfaces

The PROTO mechanism doesn't provide extensibility but rather enables the definition of a sub-scene in a more compact way. This sub-scene may represent a feature (e.g. a button). Typically, a PROTO is used when a feature needs to be repeated multiple times and involve many identical operations but customized each time; a PROTO is equivalent to a macro in programming languages.

The JavaScript language can be used in the scene to define a run-time object that performs simple logic. The Java language is typically used for applications with complex logic.

It is important to note that while JavaScript is defined in a Script node as part of the scene graph, Java language extensions are completely separated from the scene graph.

In the reminder of this section, MPEG-J is first analyzed from the stand-point of creating applications. Then, using the scene controller pattern described in the previous sections, an implementation of a terminal using the features of the pattern specification and enabling applications is described.

2.2 Analysis of MPEG-J

MPEG-J defines Java extensions for MPEG-4 terminals. It has two important characteristics, listed below (also see ISO/IEC 14496-11, Coding of audio-visual objects, Part 11: Scene description (BIFS) and Application engine):
a) the capability to allow graceful degradation under limited or time varying resources, and
b) the ability to respond to user interaction and provide enhanced multimedia functionality.

MPEG-J consists of the following APIs: Network, Resource, Decoder, and Scene. Of particular interest for the system and method described in this document is the Scene API (see the ISO/IEC document referred to above). The Scene API provides a mechanism by which MPEG-J applications access and manipulate the scene used for composition by the BIFS player. It is a low-level interface, allowing the MPEG-J application to monitor events in the scene, and modify the scene tree in a programmatic way. Nodes may also be created and manipulated, but only the fields of nodes that have been instanced with DEF are accessible to the MPEG-J application. The last sentence implies that the scene API can only access nodes that have been instanced with a DEF name or identifier. Runtime creation of nodes is of paramount importance for applications.

The scene API has been designed for querying nodes, and each node has a node type associated to it. This node type is defined by the pattern architecture described herein. This limits the extensibility of the scene because an application cannot create custom nodes. In typical applications, creating custom nodes is very important so to optimize the rendering performance with application-specific nodes or simply to extend the capabilities of the standard.

Creating custom nodes for rendering purposes means to be able to call the renderer for graphical rendering. MPEG-J and MPEG-4 don't provide any such mechanism. In fact, the Renderer API only supports notification of exceptional conditions (during rendering) and notification of frame completion when an application registers with it for this. See the ISO/IEC document referred to above.

For 2D scenes, there might not exist standard low-level APIs but, from a Java point of view, Java 2D is the de facto standard. For 3D scenes, OpenGL is the de facto standard API. While scene management might not be an issue in 2D, it is of paramount importance in 3D. In the system and method described herein, therefore, the renderer utilizes OpenGL. It should be noted that this configuration is specified in the MPEG-4 Part 21 and JSR-239 specifications (July 2004).

2.3 Scene Controllers for VRML/BIFS Sensors

VRML and BIFS define Sensor nodes as elements of a scene description that enable the user to interact with other objects in the scene. A special sensor, the TimeSensor node, is a timer that generates time events. Other sensors define geometric areas (meshes) that can generate events when an object collides with them or when a user interacts with them. These behaviors are easily implemented with scene controllers in accordance with the invention.

For user interaction with meshes, a ray from the current viewpoint to the user's sensor position on the screen can be cast onto the scene. The intersection of this ray with test models of visible and selectable meshes will either return nothing, if there is no intersection, or will return the geometric information at the point of intersection with a mesh. This is done with a SceneController using the postRender( ) method, since picking is always done after rendering the scene.

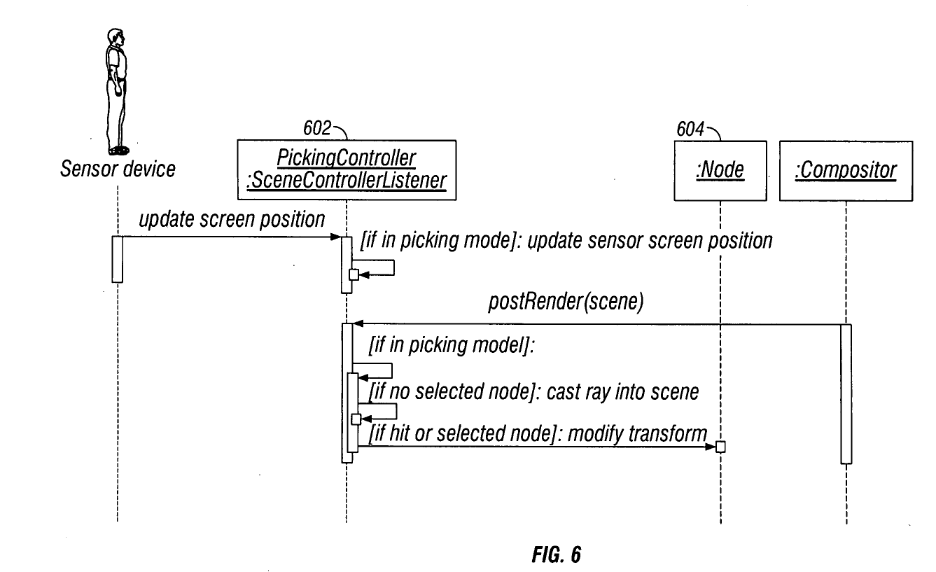

FIG. 6 shows the sequence diagram for such a picking controller 602, enough for TouchSensor node 604. For SphereSensor and CylinderSensor nodes, the same scene controller is used and, when a mesh is picked, movements of the user's sensor will modify the local coordinate system of the mesh in a spherical or cylindrical way respectively.

A VisibilitySensor node generates an event when its attached geometry is visible i.e. when its attached geometry is within the view frustrum of the current camera.

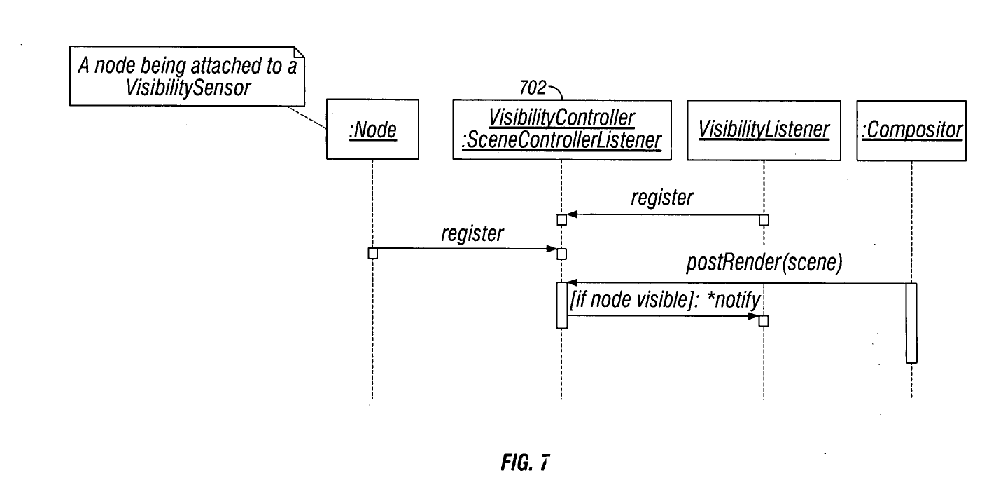

FIG. 7 defines a possible sequence of execution for such feature using scene controllers.

Collision detection can be implemented as for the VisibilitySensor 702 in FIG. 7. Nodes that must generate events when colliding are registered to a CollisionController, which is yet another example of a dedicated scene controller. When two nodes collide with one another, all CollisionListeners interested in this information are notified.

Visibility-Listener, Proximity-Listener, and Collision-Listener interfaces can be implemented by any object, not necessarily nodes as the MPEG-4 specification currently implies. This enables an application to trigger custom behaviors in response to these events. For example, in a shooting game, when a bullet hits a target, the application could make the target explode and display a message “you win”.

This section has demonstrated that any behavioral features of VRML/BIFS can be implemented using the scene controller pattern described in accordance with the invention. This section has also demonstrated that such behavioral features are better handled by an application using the SceneController pattern that would efficiently tailor them for its purposes.

3 Implementation of MPEG-4 BIFS and AFX Decoders Using Scene Controllers

For MPEG-4 BIFS (see the document ISO/IEC 14496-11, Coding of audio-visual objects, Part 11: Scene description (BIFS) and Application engine (MPEG-J)), for synthetic video objects (see the document ISO/IEC 14496-2, Coding of Audio-Visual Objects: Visual), and for AFX (see the document ISO/IEC 14496-16, Coding of audio-visual objects, Part 16: Animation Framework eXtension (AFX)), decoders receive data packets (also called access units) from an InputStream or DataSource. The InputStream can come from a file, a socket, or any object in an application. These decoders generate commands that modify the scene, the nodes, and their values when their times mature.

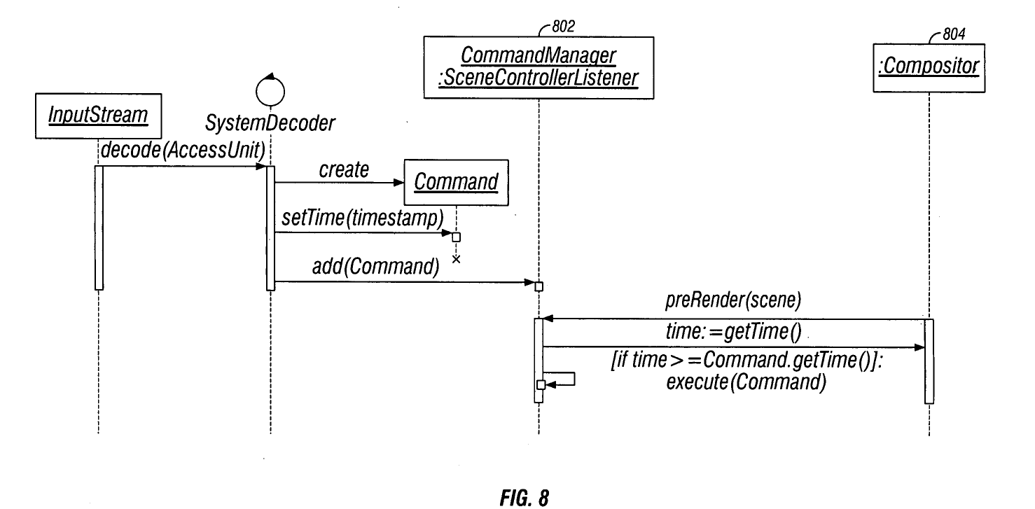

FIG. 8 shows the implementation of such decoders using the scene controller pattern described herein. The CommandManager 802 in FIG. 8 is a member of the Compositor class and is unique. For all such decoders, the CommandManager is the composition buffer (CB) or “decoded BIFS” of the MPEG-4 architecture described in FIG. 1. Commands are added to the CommandManager once they are decoded by the decoder. At the rendering frame rate, the Compositor 804 calls the CommandManager that compares the current compositor time with commands that have been added. If their time is less than the compositor time, they are executed on the scene. Depending on the memory resource available on the terminal, the CommandManager may decide to drop commands and resynchronize at the next intra-frame or request the decoder to resynchronize at the next intra-frame.

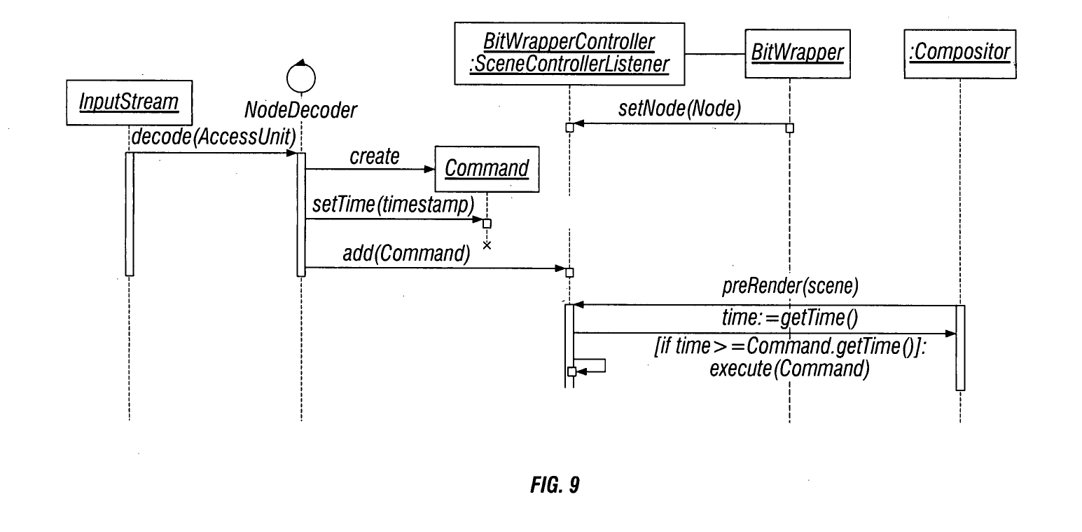

AFX also defines an extensible way of attaching a node-specific decoder for some nodes via the BitWrapper node. A BitWrapper encapsulates the node whose attributes' values will come from a dedicated stream using a dedicated encoding algorithm. Not only this mechanism is used for AFX nodes but it also provides more compressed representations for existing nodes defined in earlier versions of MPEG-4 specification. FIG. 9 shows how to implement such behavior. Such decoders typically output commands that modify multiple attributes of a node, and an implementation should avoid unnecessary duplication (or copy) of values between the decoder, command, and the node.

As shown in FIG. 8 and FIG. 9, the decoder operates in its own thread; this thread is different from the Compositor or Rendering thread. If the content uses many decoders, precautions must be taken to avoid too many threads running at the same time, which would lower the overall performance of the system. A solution is to use a thread pool or the Worker Thread pattern. Those skilled in the art will understand that a Worker Thread pattern is a thread that gets activated upon a client request.

4 Scene Controller Usage for Downloadable Multimedia Applications

The discussion in the previous sections focused on implementing the scene controller pattern in the MPEG-4 standard and in particular its programmatic interface MPEG-J. However, from this discussion it should be clear that the SceneController pattern described herein is a generic pattern that can be used with any downloadable application to a terminal. The SceneController pattern provides a logical binding between the terminal and the application for controlling what is drawn (or rendered) on the display of the terminal. It enables an application to modify a scene (or scene graph) before and after the scene is drawn.

While many multimedia standards provide a scene description that is represented in the terminal as a scene graph, one must note that a scene graph is only a high-level representation of a partitioning of a scene. When the scene graph is traversed, this results in a sequence of low-level graphic operations such as OpenGL calls to the graphic card. Therefore, the scene controller pattern described in this document is applicable to applications with access to low-level graphic operations. In the case of Java bindings, the scene controller pattern can be used with low-level APIs such as JSR-231, JSR-239, or higher-level APIs such as JSR-184, Java3D, and so on. Typically, simple multimedia applications tend to prefer using a scene graph but complex applications such as games prefer using low-level operations; the scene controller pattern may be used for all.

5 Hardware Implementation

The multimedia terminal having the scene controller pattern described above (see FIG. 1) can be implemented in a conventional computer device. The computer device will typically include a processor, memory for storing program instructions and data, interfaces to associated input/output devices, and facility for network communications. Such devices include desktop computers, laptop computers, Personal Digital Assistant (PDA) devices, telephones, game consoles, and other devices that are capable of providing a rich media experience for the user.

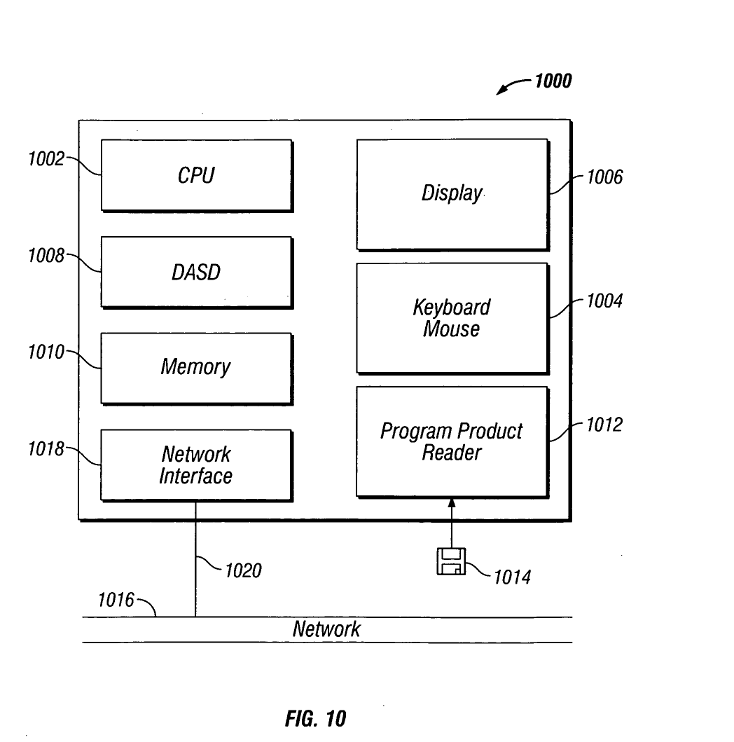

FIG. 10 is a block diagram of an exemplary computer device 1000 such as might be used to implement the multimedia terminal described above. The computer 1000 operates under control of a central processor unit (CPU) 1002, such as a “Pentium” microprocessor and associated integrated circuit chips, available from Intel Corporation of Santa Clara, Calif., USA. Devices such as PDAs, telephones, and game consoles will typically use alternative processors. A user can input commands and data from a keyboard and mouse 1004 and can view inputs and computer output at a display device 1006. The display is typically a video monitor or flat panel screen device. The computer device 1000 also includes a direct access storage device (DASD) 1008, such as a hard disk drive. The memory 1010 typically comprises volatile semiconductor random access memory (RAM) and may include read-only memory (ROM). The computer device preferably includes a program product reader 1012 that accepts a program product storage device 1014, from which the program product reader can read data (and to which it can optionally write data). The program product reader can comprise, for example, a disk drive or external storage slot, and the program product storage device can comprise removable storage media such as a CD data disc, or a memory card, or other external data store. The computer device 1000 may communicate with other computers over the network 1016 through a network interface 1018 that enables communication over a connection 1020 between the network and the computer device. The network can comprise a wired connection or can comprise a wireless network connection.

The CPU 1002 operates under control of programming instructions that are temporarily stored in the memory 1010 of the computer 1000. The programming steps may include a software program, such as a program that implements the multimedia terminal described herein. The programming instructions can be received from ROM, the DASD 1008, through the program product storage device 1014, or through the network connection 1020. The storage drive 1012 can receive a program product 1014, read programming instructions recorded thereon, and transfer the programming instructions into the memory 1010 for execution by the CPU 1002. As noted above, the program product storage device can include any one of multiple removable media having recorded computer-readable instructions, including CD data storage discs and data cards. Other suitable external data stores include SIMs, PCMCIA cards, memory cards, and external USB memory drives). In this way, the processing steps necessary for operation in accordance with the invention can be embodied on a program product.

Alternatively, the program instructions can be received into the operating memory 1010 over the network 1016. In the network method, the computer device 1000 receives data including program instructions into the memory 1010 through the network interface 1018 after network communication has been established over the network connection 1020 by well-known methods that will be understood by those skilled in the art without further explanation. The program steps are then executed by the CPU.

### 6 Additional Embodiments

Thus, as noted above, the SceneController pattern described herein can be used to manage components of a terminal application other than for scene rendering. For example, decoders can be implemented so that a registered application can be listening for decoder events. In that situation, a decoder object will be implemented that generates decoding events, such as command processing. A decoder manager object, analogous to the SceneControllerManager object described above, will control processing of received commands to be decoded and processed. The same sequence of operations for the SceneController will apply to such decoders and hence the same advantages will accrue for the decoder as described above for the scene controller: there is no need for complex multi-threading management and therefore much more efficient usage of resources (and for rendering much higher frame rates) can be obtained. Thus, the SceneController pattern described in this document is not limited to performing control of scene processing, but comprises a pattern that can be used in a variety of processing contexts.

The present invention has been described above in terms of a presently preferred embodiment so that an understanding of the present invention can be conveyed. There are, however, many configurations for the system and method not specifically described herein but with which the present invention is applicable. The present invention should therefore not be seen as limited to the particular embodiments described herein, but rather, it should be understood that the present invention has wide applicability with respect to multimedia applications generally. All modifications, variations, or equivalent arrangements and implementations that are within the scope of the attached claims should therefore be considered within the scope of the invention.

1. A computer system comprising:
a computer device having an operating system that supports execution of applications installed at the computer device for display of scenes;
a terminal application, executed in conjunction with the operating system, that includes a scene controller pattern that checks the status of an input to the computer device for every frame of a scene description received from a multimedia application, updates the described scene during a rendering operation, and displays the scene at a multimedia display of the computer device.

2. A system as defined in claim 1, further including a scene manager object that inherits from the scene controller pattern and controls the rendering of a frame of the scene description, in response to user inputs that are provided after the scene description is received from an application.

3. A system as defined in claim 2, wherein the scene controller pattern defines a SceneControllerListener object that listens to messages from the scene manager that specify terminal events produced in response to user input that manipulates the scene.

4. A system as defined in claim 1, wherein:
the scene controller pattern includes a SceneControllerManager object and a SceneControllerListener object, wherein the SceneControllerListener listens for events from a SceneControllerManager and
the terminal application includes at least one of a Renderer object that performs rendering operations and a Compositor object that performs compositing operations and inherit from the SceneControllerManager.

5. A system as defined in claim 4, wherein the SceneControllerManager controls the Compositor and Renderer and processes instructions comprising scene descriptions and drawing operations.

6. A system as defined in claim 4, wherein the SceneControllerManager manages one or more SceneControllerListener objects that are called by the SceneControllerManager once at initialization to initialize their resources, prior to rendering a frame, after rendering a frame, and at finalization time to clean up resources used by the SceneControllerListener including those created at initialization.

7. A system as defined in claim 1, wherein the terminal includes one or more scene listener objects, and wherein the terminal receives frame descriptions from a multimedia application and renders the frame description on the multimedia display, and further permits the multimedia application to modify the scene being drawn on the display during the frame rendering by querying the scene listener objects for scene modifications.

8. A system as defined in claim 7, wherein the scene modifications comprise modifying events received at the terminal that are produced from user inputs.

9. A system as defined in claim 7, wherein each scene listener object may execute modifications to the scene and provide the modifications to the scene manager prior to rendering of the frame.

10. A system as defined in claim 7, wherein the scene manager calls each scene listener object in a predetermined sequence to determine any events produced from the user.

11. A system as defined in claim 1, further including a resource manager object that inherits from the scene controller pattern and produces a computer device output, and controls the operation of a computer device resource such that the resource manager object listens for messages produced by the resource, and controls operation of the resource in response to the events prior to producing the computer device output.

12. A system as defined in claim 11, wherein the resource manager object comprises a scene manager and the computer device resource comprises a multimedia display of the computer device.

13. A system as defined in claim 11, wherein the resource manager object comprises a decoder manager and the computer device resource comprises a decoder.

14. A system as defined in claim 1, wherein the scene controller pattern processes instructions from the multimedia application that support immediate mode access to a graphics processor of the computer device.

15. A method of processing a scene description of a multimedia application with a terminal application of a computer device; the method comprising:
initializing a scene controller listener upon launch of the multimedia application;
receiving a frame from an application for rendering and, for each frame received, calling a pre-processing method of the scene controller listener for rendering of the frame, and calling a post-processing method of the scene controller listener for processing of user inputs to the frame being rendered; and
displaying the frame.

16. A method as defined in claim 15, wherein:
receiving a frame comprises receiving a scene description from the multimedia application at the terminal application and processing the scene description with a scene manager object that implements a scene controller pattern and that controls the rendering of a scene description, checking the status of an input to the computer device for every frame of the scene description, and updating the described scene during a rendering operation; and
displaying the frame comprises producing the scene at a multimedia display of the computer device in response to user inputs that are provided after the scene description is received from the multimedia application, updating the displayed image with appropriate post-processing visual effects, and performing interaction or collision detection between objects and the user inputs.

17. A method as defined in claim 16, wherein:
the scene manager object is an object defined by the scene controller pattern; and
checking, updating, and rendering are controlled by a SceneControllerListener object that is defined by the scene controller pattern such that the SceneControllerListener object listens to messages from the scene manager that specify terminal events produced in response to user input that manipulates the scene.

18. A method as defined in claim 16, wherein:
checking comprises listening for events from a SceneControllerManager object with a SceneControllerListener object, wherein the SceneControllerManager object and the SceneControllerListener object are defined by the scene controller pattern; and
producing the scene comprises performing rendering operations with a Renderer object and performing compositing operations with a Compositor object of the terminal that both inherit from the SceneControllerManager.

19. A method as defined in claim 18, wherein the SceneControllerManager calls the SceneControllerListener objects once at initialization to initialize their resources prior to rendering a frame, after rendering a frame, and at finalization time to clean up resources used by the SceneControllerListener, including those created at initialization.

20. A method as defined in claim 15, further including
receiving a computer device output from a resource manager object that inherits from the scene controller pattern, and
controlling the operation of a computer device resource such that the resource manager object listens for messages produced by the resource, and controls operation of the resource in response to the events prior to producing the computer device output.

21. A method as defined in claim 20, wherein the resource manager object comprises a scene manager and the computer device resource comprises a multimedia display of the computer device.

22. A method as defined in claim 20, wherein the resource manager object comprises a decoder manager and the computer device resource comprises a decoder.

23. A method as defined in claim 15, wherein the scene controller pattern processes instructions from the multimedia application that support immediate mode access to a graphics processor of the computer device.

24. A program product for use in a computer that executes program instructions recorded in a computer-readable media to perform a method of operating the computer for processing a scene description of a multimedia application with a terminal application of a computer device, the program product comprising:
a recordable media;
a plurality of computer-readable instructions executable by the computer to perform a method comprising:
initializing a scene controller listener upon launch of the multimedia application;
receiving a frame from an application for rendering and, for each frame received, calling a pre-processing method of the scene controller listener for rendering of the frame, and calling a post-processing method of the scene controller listener for processing of user inputs to the frame being rendered; and
displaying the frame.

25. A program product as defined in claim 24, wherein:
receiving a frame comprises receiving a scene description from the multimedia application at the terminal application and processing the scene description with a scene manager object that implements a sScene cController pattern and that controls the rendering of a scene description, checking the status of an input to the computer device for every frame of the scene description, and updating the described scene during a rendering operation; and
displaying the frame comprises producing the scene at a multimedia display of the computer device in response to user inputs that are provided after the scene description is received from the multimedia application, updating the displayed image with appropriate post-processing visual effects, and performing interaction or collision detection between objects and the user inputs.

26. A program product as defined in claim 25, wherein:
the scene manager object is an object defined by the sScene cController pattern; and
checking, updating, and rendering are controlled by a SceneControllerListener object that is defined by the sScene cController pattern such that the SceneControllerListener object listens to messages from the scene manager that specify terminal events produced in response to user input that manipulates the scene.

27. A program product as defined in claim 25, wherein:
checking comprises listening for events from a SceneControllerManager object with a SceneControllerListener object, wherein the SceneControllerManager object and the SceneControllerListener object are defined by the sScene cController pattern; and
producing the scene comprises performing rendering operations with a Renderer object and performing compositing operations with a Compositor object of the terminal that both inherit from the SceneControllerManager.

28. A program product as defined in claim 27, wherein the SceneControllerManager calls the SceneControllerListener objects once at initialization to initialize their resources prior to rendering a frame, after rendering a frame, and at finalization time to clean up resources used by the SceneControllerListener, including those created at initialization.

29. A program product as defined in claim 24, further including
receiving a computer device output from a resource manager object that inherits from the scene controller pattern, and
controlling the operation of a computer device resource such that the resource manager object listens for messages produced by the resource, and controls operation of the resource in response to the events prior to producing the computer device output.

30. A program product as defined in claim 29, wherein the resource manager object comprises a scene manager and the computer device resource comprises a multimedia display of the computer device.

31. A program product as defined in claim 29, wherein the resource manager object comprises a decoder manager and the computer device resource comprises a decoder.

32. A program product as defined in claim 24, wherein the scene controller pattern processes instructions from the multimedia application that support immediate mode access to a graphics processor of the computer device.
